(19) United States
(12) Patent Application Publication
(10) Pub. No.: US 2004/0243540 A1
(43) Pub. Date: Dec. 2, 2004

(54) Method and device for monitoring and analyzing signals

(76) Inventors: Scott A. Moskowitz, Miami, FL (US); Michael W. Berry, Albuquerque, NM (US)

Correspondence Address: Scott A. Moskowitz, 16711 Collins Avenue #2505, Miami, FL, 33160, US

(21) Appl. No.: 10/805,484

(22) Filed: Mar. 22, 2004

Related U.S. Application Data
(63) Continuation of application No. 09/671,739, filed on Sep. 29, 2000.
Application No. 09/671,739 is a continuation-in-part of application No. 09/657,181, filed on Sep. 7, 2000.

(51) Int. Cl. G06F 7/00

(52) U.S. Cl. 707/1

(57) ABSTRACT

A method and system for monitoring and analyzing at least one signal are disclosed. An abstract of at least one reference signal is generated and stored in a reference database. An abstract of a query signal to be analyzed is then generated so that the abstract of the query signal can be compared to the abstracts stored in the reference database for a match. The method and system may optionally be used to record information about the query signals, the number of matches recorded, and other useful information about the query signals. Moreover, the method by which abstracts are generated can be programmable based upon selectable criteria. The system can also be programmed with error control software so as to avoid the re-occurrence of a query signal that matches more than one signal stored in the reference database.

### CROSS-REFERENCE TO RELATED APPLICATIONS

This application is a continuation of U.S. patent application Ser. No. 09/671,739, filed Sep. 29, 2000, which is a continuation-in-part of U.S. patent application Ser. No. 09/657,181, filed Sep. 7, 2000, entitled, “Method and Device for Monitoring and Analyzing Signals.”

This application claims the benefit of pending U.S. patent application Ser. No. 08/999,766, filed Jul. 23, 1997, entitled “Steganographic Method and Device”; pending U.S. patent application Ser. No. 08/772,222, filed Dec. 20, 1996, entitled “Z-Transform Implementation of Digital Watermarks”; pending U.S. patent application Ser. No. 09/456,319, filed Dec. 8, 1999, entitled “Transform Implementation of Digital Watermarks”; pending U.S. patent application Ser. No. 08/674,726, filed Jul. 2, 1996, entitled “Exchange Mechanisms for Digital Information Packages with Bandwidth Securitization, Multichannel Digital Watermarks, and Key Management”; pending U.S. patent application Ser. No. 09/545,589, filed Apr. 7, 2000, entitled “Method and System for Digital Watermarking”; pending U.S. patent application Ser. No. 09/046,627, filed Mar. 24, 1998, entitled “Method for Combining Transfer Function with Predetermined Key Creation”; pending U.S. patent application Ser. No. 09/053,628, filed Apr. 2, 1998, entitled “Multiple Transform Utilization and Application for Secure Digital Watermarking”; pending U.S. patent application Ser. No. 09/281,279, filed Mar. 30, 1999, entitled “Optimization Methods for the Insertion, Protection, and Detection . . . ”; U.S. patent application Ser. No. 09,594,719, filed Jun. 16, 2000, entitled “Utilizing Data Reduction in Steganographic and Cryptographic Systems” (which is a continuation-in-part of PCT application No. PCT/US00/06522, filed Mar. 14, 2000, which PCT application claimed priority to U.S. Provisional Application No. 60/125,990, filed Mar. 24, 1999); pending U.S. Application No. 60/169,274, filed Dec. 7, 1999, entitled “Systems, Methods And Devices For Trusted Transactions”; and PCT Application No. PCT/US00/21189, filed Aug. 4, 2000 (which claims priority to U.S. Patent Application Ser. No. 60/147,134, filed Aug. 4, 1999, and to U.S. Patent Application No. 60/213,489, filed Jun. 23, 2000, both of which are entitled, “A Secure Personal Content Server”). The previously identified patents and/or patent applications are hereby incorporated by reference, in their entireties.

In addition, this application hereby incorporates by reference, as if fully stated herein, the total disclosures of U.S. Pat. No. 5,613,004 “Steganographic Method and Device”; U.S. Pat. No. 5,745,569 “Method for Stega-Cipher Protection of Computer Code”; and U.S. Pat. No. 5,889,868 “Optimization Methods for the Insertion, Protection, and Detection of Digital Watermarks in Digitized Data.”

### BACKGROUND OF THE INVENTION

1. Field of the Invention

The invention relates to the monitoring and analysis of digital information. A method and device are described which relate to signal recognition to enhance identification and monitoring activities.

2. Description of the Related Art

Many methods and protocols are known for transmitting data in digital form for multimedia applications (including computer applications delivered over public networks such as the internet or World Wide Web (“WWW”). These methods may include protocols for the compression of data, such that it may more readily and quickly be delivered over limited bandwidth data lines. Among standard protocols for data compression of digital files may be mentioned the MPEG compression standards for audio and video digital compression, promulgated by the Moving Picture Experts Group. Numerous standard reference works and patents discuss such compression and transmission standards for digitized information.

Digital watermarks help to authenticate the content of digitized multimedia information, and can also discourage piracy. Because piracy is clearly a disincentive to the digital distribution of copyrighted content, establishment of responsibility for copies and derivative copies of such works is invaluable. In considering the various forms of multimedia content, whether “master,” stereo, NTSC video, audio tape or compact disc, tolerance of quality will vary with individuals and affect the underlying commercial and aesthetic value of the content. It is desirable to tie copyrights, ownership rights, purchaser information or some combination of these and related data into the content in such a manner that the content must undergo damage, and therefore reduction of its value, with subsequent, unauthorized distribution, commercial or otherwise. Digital watermarks address many of these concerns. A general discussion of digital watermarking as it has been applied in the art may be found in U.S. Pat. No. 5,687,236 (whose specification is incorporated in whole herein by reference).

Further applications of basic digital watermarking functionality have also been developed. Examples of such applications are shown in U.S. Pat. No. 5,889,868 (whose specification is incorporated in whole herein by reference). Such applications have been drawn, for instance, to implementations of digital watermarks that were deemed most suited to particular transmissions, or particular distribution and storage mediums, given the nature of digitally sampled audio, video, and other multimedia works. There have also been developed techniques for adapting watermark application parameters to the individual characteristics of a given digital sample stream, and for implementation of digital watermarks that are feature-based—i.e., a system in which watermark information is not carried in individual samples, but is carried in the relationships between multiple samples, such as in a waveform shape. For instance, natural extensions may be added to digital watermarks that may also separate frequencies (color or audio), channels in 3D while utilizing discreteness in feature-based encoding only known to those with pseudo-random keys (i.e., cryptographic keys) or possibly tools to access such information, which may one day exist on a quantum level.

A matter of general weakness in digital watermark technology relates directly to the manner of implementation of the watermark. Many approaches to digital watermarking leave detection and decode control with the implementing party of the digital watermark, not the creator of the work to be protected. This weakness removes proper economic incentives for improvement of the technology. One specific form of exploitation mostly regards efforts to obscure subsequent watermark detection. Others regard successful over encoding using the same watermarking process at a subsequent time. Yet another way to perform secure digital watermark implementation is through “key-based” approaches.

### SUMMARY OF THE INVENTION

According to one embodiment of the present invention, an electronic system for monitoring and analyzing at least one signal is disclosed, which system comprises: a first input for receiving at least one reference signal to be monitored, a first processor for creating an abstract of each reference signal input to the first processor through the first input; a second input for receiving at least one query signal to be analyzed, a second processor for creating an abstract of each query signal; a reference database for storing abstracts of each at least one reference signal; and a comparing device for comparing an abstract of the at least one query signal to the abstracts stored in the reference database to determine if the abstract of the at least one query signal matches any of the stored abstracts, and a means for non-owners of the reference database to submit abstracts for comparison to the reference database, the means providing a database rights and restriction report, the database rights and restriction report comprising the attendant rights and restrictions associated with any stored abstract associated with a positive result.

According to another embodiment of the present invention, an electronic system for monitoring and analyzing at least one signal, comprising: a first input for receiving a plurality of reference signals to be monitored; a first processor for creating a plurality of abstracts corresponding to the plurality of reference signals; a reference database for storing the reference signal abstracts; a second input for receiving a query signal to be analyzed; a second processor for creating an abstract of the query signal; a comparing device that compares the query signal abstract to the reference signal abstracts and determines if the query signal abstract matches at least one of the reference signal abstracts; and a means for linking the query signal abstract to the reference signal corresponding to the matching reference signal abstract.

### DETAILED DESCRIPTION OF THE INVENTION

While there are many approaches to data reduction that can be utilized, a primary concern is the ability to reduce the digital signal in such a manner as to retain a “perceptual relationship” between the original signal and its data reduced version. This relationship may either be mathematically discernible or a result of market-dictated needs. A goal of the present invention is to afford a more consistent means for classifying signals than proprietary, related text-based approaches. A simple analogy is the way in which a forensic investigator uses a sketch artist to assist in determining the identity of a human.

In one embodiment of the invention, the abstract of a signal may be generated by the following steps: 1) analyze the characteristics of each signal in a group of audible/perceptible variations for the same signal (e.g., analyze each of five versions of the same song—which versions may have the same lyrics and music but which are sung by different artists); and 2) select those characteristics which achieve remain relatively constant (or in other words, which have minimum variation) for each of the signals in the group. Optionally, the null case may be defined using those characteristics which are common to each member of the group of versions.

Lossless and lossy compression schemes are appropriate candidates for data reduction technologies, as are those subset of approaches that are based on perceptual models, such as AAC, MP3, TwinVQ, JPEG, GIF, MPEG, etc. Where spectral transforms fail to assist in greater data reduction of the signal, other signal characteristics can be identified as candidates for further data reduction. Linear predictive coding (LPC), z-transform analysis, root mean square (rms), signal to peak, etc. may be appropriate tools to measure signal characteristics, but other approaches or combinations of signal characteristic analysis are contemplated. While such signal characteristics may assist in determining particular applications of the present invention, a generalized approach to signal recognition is necessary to optimize the deployment and use of the present invention.

Increasingly, valuable information is being created and stored in digital form. For example, music, photographs and motion pictures can all be stored and transmitted as a series of binary digits—1's and 0's. Digital techniques permit the original information to be duplicated repeatedly with perfect or near-perfect accuracy, and each copy is perceived by viewers or listeners as indistinguishable from the original signal. Unfortunately, digital techniques also permit the information to be easily copied without the owner's permission. While digital representations of analog waveforms may be analyzed by perceptually-based or perceptually-limited analysis it is usually costly and time-consuming to model the processes of the highly effective ability of humans to identify and recognize a signal. In those applications where analog signals require analysis, the cost of digitizing the analog signal is minimal when compared to the benefits of increased accuracy and speed of signal analysis and monitoring when the processes contemplated by this invention are utilized.

The present invention relates to identification of digitally-sampled information, such as images, audio and video. Traditional methods of identification and monitoring of those signals do not rely on “perceptual quality,” but rather upon a separate and additional signal. Within this application, such signals will be called “additive signals” as they provide information about the original images, audio or video, but such information is in addition to the original signal. One traditional, text-based additive signal is title and author information. The title and author, for example, is information about a book, but it is in addition to the text of the book. If a book is being duplicated digitally, the title and author could provide one means of monitoring the number of times the text is being duplicated, for example, through an Internet download.

Reliance on an additive signal has many shortcomings. For instance, someone must first incorporate the additive signal within the digital data being transmitted by, for example, concatenation or through an embedding process. Such an additive signal, however, can be easily identified and removed by one who wants to utilize the original signal without paying for its usage. If the original signal itself is used to identify the content, an unauthorized user could not avoid payment of a royalty simply by removing the additive signal—because there is no additive signal to remove.

One known additive signal that may be used is a digital watermark—which ideally cannot be removed without perceptually altering the original signal. A watermark may also be used as a monitoring signal (for example, by encoding an identifier that uniquely identifies the original digital signal into which the identifier is being embedded). A digital watermark used for monitoring is also an additive signal, and such a signal may make it difficult for the user who wants to duplicate a signal without paying a royalty—mainly by degrading the perceptual quality of the original signal if the watermark (and hence the additive monitoring signal) is removed. This is, however, is a different solution to the problem.

Digital watermarks may increase the value of monitoring techniques by increasing the integrity of the embedded data and by indicating tampering of either the original content signal or the monitoring signal. Moreover, the design of a watermarking embedding algorithm is closely related to the perceptibility of noise in any given signal and can represent an ideal subset of the original signal: the watermark bits are an inverse of the signal to the extent that lossy compression schemes, which can be used, for instance, to optimize a waternarking embedding scheme, can yield information about the extent to which a data signal can be compressed while holding steadfast to the design requirement that the compressed signal maintain its perceptual relationship with the original, uncompressed signal. By describing those bits that are candidates for imperceptible embedding of watermark bits, further data reduction may be applied on the candidate watermarks as an example of retaining a logical and perceptible relationship with the original uncompressed signal.

The present invention, however, is directed to the identification of a digital signal—whether text, audio, or video—using only the digital signal itself and then monitoring the number of times the signal is duplicated. This is achieved by using the underlying content signal as the identifier. Of course, the present invention may be used in conjunction with watermarking technology (including the use of keys to accomplish secure digital watermarking), but watermarking is not necessary to practice the present invention. Keys for watermarking may have many forms, including: descriptions of the original carrier file formatting, mapping of embedded data (actually imperceptible changes made to the carrier signal and referenced to the predetermined key or key pairs), assisting in establishing the watermark message data integrity (by incorporation of special one way functions in the watermark message data or key), etc. Discussions of these systems in the patents and pending patent applications are incorporated by reference above. The “recognition” of a particular signal or an instance of its transmission, and its monitoring are operations that may be optimized through the use of digital watermark analysis.

A practical difference between the two approaches of using a separate, additive monitoring signal and using the original signal itself as the monitoring signal is that of control. If a separate signal is used for monitoring, then the originator of the text, audio or video signal being transmitted and the entity doing the monitoring have to agree as to the nature of the separate signal to be used for monitoring—otherwise, the entity doing the monitoring would not know where to look, for what to look, or how to interpret the monitoring signal once it was identified and detected. On the other hand, if the original signal itself is used as a monitoring signal, then no such agreement is necessary. Moreover, a more logical and self-sufficient relationship between the original and its data-reduced abstract enhances the transparency of any resulting monitoring efforts. The entity doing the monitoring is not looking for a separate, additive monitoring system, and further, does not have to interpret the content of the monitoring signal.

Monitoring implementations can be handled by robust watermark techniques (those techniques that are able to survive many signal manipulations but are not inherently “secure” for verification of a carrier signal absent a logically-related watermarking key) and forensic watermark techniques (which enable embedding of watermarks that are not able to survive perceptible alteration of the carrier signal and thus enable detection of tampering with the originally watermarked carrier signal). The techniques have obvious trade-offs between speed, performance and security of the embedded watermark data.

In other disclosures, the present inventors suggest improvements and implementations that relate to digital watermarks in particular and embedded signaling in general. A digital watermark may be used to “tag” content in a manner that is not humanly-perceptible, in order to ensure that the human perception of the signal quality is maintained. Watermarking, however, must inherently alter at least one data bit of the original signal to represent a minimal change from the original signal's “unwatermarked state.” The changes may affect only a bit, at the very least, or be dependent on information hiding relating to signal characteristics, such as phase information, differences between digitized samples, root mean square (RMS) calculations, z-transform analysis, or similar signal characteristic category.

There are weaknesses in using digital watermark technology for monitoring purposes. One weakness relates directly to the way in which watermarks are implemented. Often, the persons responsible for encoding and decoding the digital watermark are not the creator of the valuable work to be protected. As such, the creator has no input on the placement of the monitoring signal within the valuable work being protected. Hence, if a user wishing to avoid payment of the royalty finds a way to decode or remove the watermark, or at least the monitoring signal embedded in the watermark, then the unauthorized user may successfully duplicate the signal with impunity. This could occur, for example, if either of the persons responsible for encoding or decoding were to have their security compromised such that the encoding or decoding algorithms were discovered by the unauthorized user.

According to the present invention, no such disadvantages exist because the creator need not rely on anyone to insert a monitoring signal because no monitoring signals are necessary. Instead, the creator's work itself is used as the monitoring signal. Accordingly, the value in the signal will have a strong relationship with its recognizability.

By way of improving methods for efficient monitoring as well as effective confirmation of the identity of a digitally-sampled signal, the present invention describes useful methods for using digital signal processing for benchmarking a novel basis for differencing signals with binary data comparisons. These techniques may be complemented with perceptual techniques, but are intended to leverage the generally decreasing cost of bandwidth and signal processing power in an age of increasing availability and exchange of digitized binary data.

So long as there exist computationally inexpensive ways of identifying an entire signal with some fractional representation or relationship with the original signal, or its perceptually observable representation, the present invention contemplates methods for faster and more accurate auditing of signals as they are played, distributed or otherwise shared amongst providers (transmitters) and consumers (receivers). The ability to massively compress a signal to its essence—which is not strictly equivalent to “lossy” or “lossless” compression schemes or perceptual coding techniques, but designed to preserve some underlying “aesthetic quality” of the signal—represents a useful means for signal analysis in a wide variety of applications. The signal analysis, however, must maintain the ability to distinguish the perceptual quality of the signals being compared. For example, a method which analyzed a portion of a song by compressing it to a single line of lyrics fails to maintain the ability to distinguish the perceptual quality of the songs being compared. Specifically, if the song “New York State of Mind” were compressed to the lyrics “I'm in a New York State of Mind,” such a compression fails to maintain the ability to distinguish between the various recorded versions of the song, say, for example between Billy Joel's recording and Barbara Streisand's recording. Such a method is, therefore, incapable of providing accurate monitoring of the artist's recordings because it can not determine which of the two artists is deserving of a royalty—unless of course, there is a separate monitoring signal to provide the name of the artist or other information sufficient to distinguish the two versions. The present invention, however, aims to maintain some level of perceptual quality of the signals being compared and would deem such a compression to be excessive.

This analogy can be made clearer if it is understood that there are a large number of approaches to compressing a signal to, say, 1/10,000^{th} of its original size, not for maintaining its signal quality to ensure computational ease for commercial quality distribution, but to assist in identification, analysis or monitoring of the signal. Most compression is either lossy or lossless and is designed with psychoacoustic or psychovisual parameters. That is to say, the signal is compressed to retain what is “humanly-perceptible.” As long as the compression successfully mimics human perception, data space may be saved when the compressed file is compared to the uncompressed or original file. While psychoacoustic and psychovisual compression has some relevance to the present invention, additional data reduction or massive compression is anticipated by the present invention. It is anticipated that the original signal may be compressed to create a realistic or self-similar representation of the original signal, so that the compressed signal can be referenced at a subsequent time as unique binary data that has computational relevance to the original signal. Depending on the application, general data reduction of the original signal can be as simple as massive compression or may relate to the watermark encoding envelope parameter (those bits which a watermarking encoding algorithm deem as candidate bits for mapping independent data or those bits deemed imperceptible to human senses but detectable to a watermark detection algorithm). In this manner, certain media which are commonly known by signal characteristics, a painting, a song, a TV commercial, a dialect, etc., may be analyzed more accurately, and perhaps, more efficiently than a text-based descriptor of the signal. So long as the sender and receiver agree that the data representation is accurate, even insofar as the data-reduction technique has logical relationships with the perceptibility of the original signal (as they must with commonly agreed to text descriptors), no independent cataloging is necessary.

In general, the present invention contemplates a signal recognition system that includes about five elements. The actual number of elements may vary depending on the number of domains in which a signal resides (for example, audio carriers reside in one domain, while visual carriers reside in at least two domains). The present invention contemplates that the number of elements will be sufficient to effectively and efficiently meet the demands of various classes of signal recognition. The design of the signal recognition that may be used with data reduction is better understood in the context of the general requirements of a pattern or signal recognition system.

The first element is the reference database, which contains information about a plurality of potential signals that will be monitored. In one form, the reference database may contain digital copies of original works of art as they are recorded by the various artists, such as digital copies of all songs that will be played by a particular radio station. In another form, the reference database may contain digital copies of abstracted works of art, such as digital copies of all songs that have been preprocessed such that the copies represent the perceptual characteristics of the original songs. In another form, the reference database may contain digital copies of processed data files, which files represent works of art that have been preprocessed in such a way as to identify those perceptual differences that can be used to differentiate one version of a work of art from another version of the same work of art, such as two or more versions of the same song. These examples have obvious application to visually communicated works such as images, trademarks, photographs, and video.

The second element is the object locator, which is segments a portion of a signal being monitored for analysis (i.e., the “monitored signal”). The segmented portion may be referred to as an “object.” As such, the signal being monitored may be thought of comprising a set of objects. A song recording, for example, can be thought of as having a multitude of objects. The objects need not be of uniform length, size, or content, but merely be a sample of the signal being monitored. Visually communicated informational signals have related objects; color and size are examples.

The third element is the feature selector, which analyzes a selected object and identifies perceptual features of the object that may be used to uniquely describe the selected object. Ideally, the feature selector can identify all, or nearly all, of the perceptual qualities of the object that differentiate it from a similarly selected object of other signals. Simply, a feature selector has a direct relationship with the perceptibility of features commonly observed. Counterfeiting, for example, is an activity which specifically seeks out features to misrepresent the authenticity of any given object. Highly granular, and arguably successful, counterfeiting is typically sought for objects that are easily recognizable and valuable, for example, currency, stamps, and trademarked or copyrighted works and objects that have value to a body politic.

The fourth element is the comparing device which compares the selected object using the features selected by the feature selector to the plurality of signals in the reference database to identify which of the signals matches the monitored signal. Depending upon how the information of the plurality of signals is stored in the reference database, and upon the available computational capacity (e.g., speed and efficiency), the exact nature of the comparison may vary. For example, the comparing device may compare the selected object directly to the signal information stored in the database. Alternatively, the comparing device may process the signal information stored in the database using input from the feature selector and then compare the selected object to the processed signal information. Alternatively, the comparing device may process the selected object using input from the feature selector and then compare the processed selected object to the signal information. Alternatively, the comparing device may process the signal information stored in the database using input from the feature selector, process the selected object using input from the feature selector, and then compare the processed selected object to the processed signal information.

The fifth element is the recorder which records information regarding the number of times a given signal is analyzed and detected. The recorder may comprise a database which keeps track of the number of times a song, image, or a movie, has been played, or may generate a serial output which can be subsequently processed to determine the total number of times various signals have been detected.

Other elements may be added to the system or incorporated into above-described elements. For example, an error handler may be incorporated into the comparing device. If the comparing device identifies multiple signals which appear to contain the object being sought for analysis or monitoring, the error handler may offer further processing in order to identify additional qualities or features in the selected object such that only one of the set of captured signals is found to contain the further analyzed selected object that actually conforms with the object thought to have been transmitted or distributed.

Moreover, one or more of the five identified elements may be implemented with software that runs on the same processor, or which uses multiple processors. In addition, the elements may incorporate dynamic approaches that utilize stochastic, heuristic, or experience-based adjustments to refine the signal analysis being conducted within the system, including, for example, the signal analyses being performed within the feature selector and the comparing device. This additional analyses may be viewed as filters that are designed to meet the expectations of accuracy or speed for any intended application.

Since maintenance of original signal quality is not required by the present invention, increased efficiencies in processing and identification of signals can be achieved. The present invention is concerns with perceptible relationships only to the extent that efficiencies can be achieved both in accuracy and speed while enabling logical relationships between an original signal and its abstract.

The challenge is to maximize the ability to sufficiently compress a signal to both retain its relationship with the original signal while reducing the data overhead to enable more efficient analysis, archiving and monitoring of these signals. In some cases, data reduction alone will not suffice: the sender and receiver must agree to the accuracy of the recognition. In other cases, agreement will actually depend on a third party who authored or created the signal in question. A digitized signal may have parameters to assist in establishing more accurate identification, for example, a “signal abstract” which naturally, or by agreement with the creator, the copyright owner or other interested parties, can be used to describe the original signal. By utilizing less than the original signal, a computationally inexpensive means of identification can be used. As long as a realistic set of conditions can be arrived at governing the relationship between a signal and its data reduced abstract, increases in effective monitoring and transparency of information data flow across communications channels is likely to result. This feature is significant in that it represents an improvement over how a digitally-sampled signal is cataloged and identified, though the use of a means that is specifically selected based upon the strengths of a general computing device and the economic needs of a particular market for the digitized information data being monitored. The additional benefit is a more open means to uniformly catalog, analyze, and monitor signals. As well, such benefits can exist for third parties, who have a significant interest in the signal but are not the sender or receiver of said information.

As a general improvement over the art, the present invention incorporates what could best be described as “computer-acoustic” and “computer-visual” modeling, where the signal abstracts are created using data reduction techniques to determine the smallest amount of data (at least a single bit) which can represent and differentiate two digitized signal representations for a given predefined signal set. Each of such representations must have at least a one bit difference with all other members of the database to differentiate each such representation from the others in the database. The predefined signal set is the object being analyzed. The signal identifier/detector should receive its parameters from a database engine. The engine will identify those characteristics (for example, the differences) that can be used to distinguish one digital signal from all other digital signals that are stored in its collection. For those digital signals or objects which are seemingly identical, except that the signal may have different performance or utilization in the newly created object, benefits over additive or text-based identifiers are achieved. Additionally, decisions regarding the success or failure of an accurate detection of any given object may be flexibly implemented or changed to reflect market-based demands of the engine. Appropriate examples are songs or works or art which have been sampled or re-produced by others who are not the original creator.

In some cases, the engine will also consider the NULL case for a generalized item not in its database, or perhaps in situations where data objects may have collisions. For some applications, the NULL case is not necessary, making the whole system faster. Example of this include databases that have fewer repetitions of objects, or systems that are intended to recognize signals with time constraints or capture all data objects. Greater efficiency in processing a relational database may be obtained because the rules for comparison are selected for the maximum efficiency of the processing hardware and/or software, whether or not the processing is based on psychoacoustic or psychovisual models. The benefits of massive data reduction, flexibility in constructing appropriate signal recognition protocols and incorporation of cryptographic techniques to further add accuracy and confidence in the system are clearly improvements over the art. For example, where the data reduced abstract needs to have further uniqueness, a hash or signature may be required. And for objects which have further uniqueness requirements, two identical instances of the object could be made unique with cryptographic techniques.

Accuracy in processing and identification may be increased by using one or more of the following fidelity evaluation functions:

1) RMS (root mean square). A RMS function may be used to assist in determining the distance between data based on mathematically determinable Euclidean distance between the beginning and end data points (bits) of a particular signal carrier.

2) Frequency weighted RMS. Different weights may be applied to different frequency components of the carrier signal before using RMS. This selective weighting can assist in further distinguishing the distance between beginning and end points of the signal carrier (at a given point in time, described as bandwidth, or the number of total bits that can be transmitted per second) and may be considered to be the mathematical equivalent of passing a carrier signal difference through a data filter and figuring the average power in the output carrier.

3) Absolute error criteria, including particularly the NULL set (described above). The NULL may be utilized in two significant cases: First, in instances where the recognized signal appears to be an identified object which is inaccurately attributed or identified to an object not handled by the database of objects; and second, where a collision of data occurs. For instance, if an artist releases a second performance of a previously recorded song, and the two performances are so similar that their differences are almost imperceptible, then the previously selected criteria may not be able to differentiate the two recordings. Hence, the database must be “recalibrated” to be able to differentiate these two versions. Similarly, if the system identifies not one, but two or more, matches for a particular search, then the database may need “recalibration” to further differentiate the two objects stored in the database.

4) Cognitive Identification. The present invention may use an experience-based analysis within a recognition engine. Once such analysis may involve mathematically determining a spectral transform or its equivalent of the carrier signal. A spectral transform enables signal processing and should maintain, for certain applications, some cognitive or perceptual relationship with the original analog waveform. As a novel feature to the present invention, additional classes may be subject to humanly-perceptible observation. For instance, an experience-based criteria which relates particularly to the envisioned or perceived accuracy of the data information object as it is used or applied in a particular market, product, or implementation. This may include a short three second segment of a commercially available and recognizable song which is used for commercials to enable recognition of the good or service being marketed. The complete song is marketed as a separately valued object from the use of a discrete segment of the song (that may be used for promotion or marketing for the complete song or for an entirely different good or service). To the extent that an owner of the song in question is able to further enable value through the licensing or agreement for use of a segment of the original signal, cognitive identification is a form of filtering to enable differentiations between different and intended uses of the same or subset of the same signal (object). The implementation relating specifically, as disclosed herein, to the predetermined identification or recognition means and/or any specified relationship with subsequent use of the identification means can be used to create a history as to how often a particular signal is misidentified, which history can then be used to optimize identification of that signal in the future. The difference between use of an excerpt of the song to promote a separate and distinct good or service and use of the excerpt to promote recognition of the song itself (for example, by the artist to sell copies of the song) relates informationally to a decision based on recognized and approved use of the song. Both the song and applications of the song in its entirety or as a subset are typically based on agreement by the creator and the sender who seeks to utilize the work. Trust in the means for identification, which can be weighted in the present invention (for example, by adjusting bit-addressable information), is an important factor in adjusting the monitoring or recognition features of the object or carrier signal, and by using any misidentification information, (including any experience-based or heuristic information), additional features of the monitored signal can be used to improve the performance of the monitoring system envisioned herein. The issue of central concern with cognitive identification is a greater understanding of the parameters by which any given object is to be analyzed. To the extent that a creator chooses varying and separate application of his object, those applications having a cognitive difference in a signal recognition sense (e.g., the whole or an excerpt), the system contemplated herein includes rules for governing the application of bit-addressable information to increase the accuracy of the database.

5) Predetermined Parameters. Finally, the predetermined parameters that are associated with a discrete case for any given object may have a significant impact upon the ability to accurately process and identify the signals. For example, if a song is transmitted over a FM carrier, then one skilled in the art will appreciate that the FM signal has a predetermined bandwidth which is different from the bandwidth of the original recording, and different even from song when played on an AM carrier, and different yet from a song played using an 8-bit Internet broadcast. Recognition of these differences, however, will permit the selection of an identification means which can be optimized for monitoring a FM broadcasted signal. In other words, the discreteness intended by the sender is limited and directed by the fidelity of the transmission means. Objects may be cataloged and assessing with the understanding that all monitoring will occur using a specific transmission fidelity. For example, a database may be optimized with the understanding that only AM broadcast signals will be monitored. For maximum efficiency, different data bases may be created for different transmission channels, e.g., AM broadcasts, FM broadcasts, Internet broadcasts, etc.

For more information on increasing efficiencies for information systems, see The Mathematical Theory of Communication (1948), by Shannon.

Because bandwidth (which in the digital domain is equated to the total number of bits that can be transmitted in a fixed period of time) is a limited resource which places limitations upon transmission capacity and information coding schemes, the importance of monitoring for information objects transmitted over any given channel may take into consideration the nature and utilization of a given channel. The supply and demand of bandwidth will have a dramatic impact on the transmission, and ultimately, upon the decision to monitor and recognize signals. A discussion of this is found in a co-pending application by the inventor under U.S. patent application Ser. No. 08/674,726 “Exchange Mechanisms for Digital Information Packages with Bandwidth Securitization, Multichannel Digital Watermarks, and Key Management,” the disclosure of which is incorporated by reference in its entirety.

If a filter is to be used in connection with the recognition or monitoring engine, it may be desirable for the filter to contemplate and consider the following factors, which affect the economics of the transmission as they relate to triggers for payment and/or relate to events requiring audits of the objects which are being transmitted: 1) time of transmission (i.e., the point in time when the transmission occurred), including whether the transmission is of a live performance); 2) location of transmission (e.g., what channel was used for transmission, which usually determines the associated cost for usage of the transmission channel); 3) the point of origination of the transmission (which may be the same for a signal carrier over many distinct channels); and 4) pre-existence of the information carrier signal (pre-recorded or newly created information carrier signal, which may require differentiation in certain markets or instances).

In the case of predetermined carrier signals (those which have been recorded and stored for subsequent use), “positional information carrier signals” are contemplated by this invention, namely, perceptual differences between the seemingly “same” information carrier that can be recognized as consumers of information seek different versions or quality levels of the same carrier signal. Perceptual differences exist between a song and its reproduction from a CD, an AM radio, and an Internet broadcast. To the extent that the creator or consumer of the signal can define a difference in any of the four criteria above, means can be derived (and programmed for selectability) to recognize and distinguish these differences. It is, however, quite possible that the ability to monitor carrier signal transmission with these factors will increase the variety and richness of available carrier signals to existing communications channels. The differentiation between an absolute case for transmission of an object, which is a time dependent event, for instance a live or real time broadcast, versus the relative case, which is prerecorded or stored for transmission at a later point in time, creates recognizable differences for signal monitoring.

The monitoring and analysis contemplated by this invention may have a variety of purposes, including, for example, the following: to determine the number of times a song is broadcast on a particular radio broadcast or Internet site; to control security though a voice-activated security system; to identify associations between a beginner's drawing and those of great artists (for example, to draw comparisons between technique, compositions, or color schemes), etc. None of these examples may be achieved with any significant degree of accuracy using a text-based analysis. Additionally, strictly text-based systems fail to fully capture the inherent value of the data recognition or monitoring information itself.

In practice, according to one embodiment of the present invention, at least one reference signal is input to a first input of a first processor. This signal may be an audio signal, a video signal, etc. The first processor receives the reference signal, and creates an abstract of the reference signal, as discussed above. As reference signal abstracts are created, they may be stored in a database.

In order to retrieve a reference signal, a query signal is input to a second processor. The first and second processors may be the same processor; in another embodiment, different processors may be used. The second processor creates an abstract of the query signal in the same manner as the first processor created an abstract of the reference signals. Once the query signal abstract is created, a comparing device “searches” the abstracts stored in the database to determine if there is a match for the query signal. If a match is found, a link is provided to the reference signal.

In one embodiment of the present invention, users may submit reference signal abstracts to the reference signal database in order to assist in the development of the database.

In one embodiment, if the user desires to access the reference signal, a transaction means may be provided so that the user may be provided with access to the reference signal.

As discussed above, the present invention may be used in conjunction with digital watermarks. In one embodiment, the reference signal may be embedded with its abstract, in a manner similar to the embedding of a digital watermark. This may be done when the reference signal is initially processed, e.g., when the reference signal abstract is created, or it may be done when the reference signal is downloaded, or at any other time.

Prior to embedding, the reference signal abstract may be preprocessed. In one embodiment, the reference signal abstract may be hashed; in another embodiment, it may be digitally signed. The keys for the authentication/digital signature may be held by a certification authority, which may include the entity that prepares or handles the signal abstraction itself. The hash or signature of the signal abstract may be dependent on the signal that is linked/subsequently downloaded.

In yet another embodiment of the present invention, the signal abstraction engine itself may be broken out for a user to check a signal that the user receives. For instance, a user may receive a signal which is referenced by the database and may want to manually confirm that it is the signal in question. This functionality may be coupled to a web browser, a caching or filtering function (such as Akamai or Inktomi), a localized device, etc. The signal abstraction engine may be further coupled to a cryptographic engine for determining additional uniqueness or authentication information that may be stored with the signal abstraction.

In yet another embodiment of the present invention, the database may act as a certification authority. For example, a signal abstract is created and sent to the database (the database can be either private or publicly accessible, the private database may have features to enable access by password or authorization protocols). The database further digitally signs the abstract and maintains the signature to enable third parties to confirm that the signal abstract is the “authorized” abstract. A separate database may be held for certification authorities to verify the signal abstract to those seeking verification. Alternatively, the certification authority may play a role in matching the signal abstract with the signal; meaning the abstraction is verified and then sent to a link for authorized versions of the song or signal. This additional feature enables the copyright owners to perhaps sign the abstracts as well to differentiate between unauthorized signal abstracts and authorized abstracts in assisting with maintenance of the authentic abstracts and/or the references to the actual signals for download. Additionally, it allows for the signal abstract to be tightly bound to any transaction that then can be enabled by matching the search results (abstract and link to the actual signal at some address in the database or some other noncontiguous database) to an actual transaction.

### EXAMPLES

In order to better appreciate and understand the present invention, the following examples are provided. These examples are provided for exemplary purposes only, and in no way limit the present invention.

### Example 1

A database of audio signals (e.g., songs) is stored or maintained by a radio station or Internet streaming company, that may select a subset of the songs are stored so that the subset may be later broadcast to listeners. The subset, for example, may comprise a sufficient number of songs to fill 24 hours of music programming (between 300 or 500 songs). Traditionally, monitoring is accomplished by embedding some identifier into the signal, or affixing the identifier to the signal, for later analysis and determination of royalty payments. Most of the traditional analysis is performed by actual persons who use play lists and other statistical approximations of audio play, including for example, data obtained through the manual (i.e., by persons) monitoring of a statistically significant sample of stations and transmission times so that an extrapolation may be made to a larger number of comparable markets.

The present invention creates a second database from the first database, wherein each of the stored audio signals in the first database is data reduced in a manner that is not likely to reflect the human perceptual quality of the signal, meaning that a significantly data-reduced signal is not likely to be played back and recognized as the original signal. As a result of the data reduction, the size of the second database (as measured in digital terms) is much smaller than the size of the first database, and is determined by the rate of compression. If, for example, if 24 hours worth of audio signals are compressed at a 10,000:1 compression rate, the reduced data could occupy a little more than 1 megabyte of data. With such a large compression rate, the data to be compared and/or analyzed may become computationally small such that computational speed and efficiency are significantly improved.

With greater compression rates, it is anticipated that similarity may exist between the data compressed abstractions of different analog signals (e.g., recordings by two different artists of the same song). The present invention contemplates the use of bit-addressable differences to distinguish between such cases. In applications where the data to be analyzed has higher value in some predetermined sense, cryptographic protocols, such as a hash or digital signature, can be used to distinguish such close cases.

In a preferred embodiment, the present invention may utilize a centralized database where copies of new recordings may be deposited to ensure that copyright owners, who authorize transmission or use of their recordings by others, can independently verify that the object is correctly monitored. The rules for the creator himself to enter his work would differ from a universally recognized number assigned by an independent authority (say, ISRC, ISBN for recordings and books respectively). Those skilled in the art of algorithmic information theory (AIT) can recognize that it is now possible to describe optimized use of binary data for content and functionality. The differences between objects must relate to decisions made by the user of the data, introducing subjective or cognitive decisions to the design of the contemplated invention as described above. To the extent that objects can have an optimized data size when compared with other objects for any given set of objects, the algorithms for data reduction would have predetermined flexibility directly related to computational efficiency and the set of objects to be monitored. The flexibility in having transparent determination of unique signal abstracts, as opposed to independent third party assignment, is likely to increase confidence in the monitoring effort by the owners of the original signals themselves. The prior art allows for no such transparency to the copyright creators.

### Example 2

Another embodiment of the invention relates to visual images, which of course, involve at least two dimensions.

Similar to the goals of a psychoacoustic model, a psychovisual model attempts to represent a visual image with less data, while preserving those perceptual qualities of the image that permit a human to recognize the original visual image. Using the very same techniques described above in connection with an audio signal, signal monitoring of visual images may be implemented.

One such application for monitoring and analyzing visual images involves a desire to find works of artists that relate to a particular theme. An example involves locating, or identifying, paintings of sunsets or sunrises. A traditional approach may involve a textual search involving a database, wherein the works of artists have been described in writing. The present invention, however, involves the scanning of an image involving a sun, compressing the data to its essential characteristics (i.e., those perceptual characteristics related to the sun) and then finding matches in a database of other visual images (stored as compressed or even uncompressed data). By studying the work of other artists using such techniques, a novice, for example, could learn much by comparing the presentations of a common theme by different artists.

Another useful application involving this type of monitoring and analyzing is the identification of photographs of potential suspects whose identity matches the sketch of a police sketch artist.

Note that combinations of the monitoring techniques discussed above may be used for audio-visual monitoring, such as video-transmission by a television station or cable station. The techniques would have to compensate, for example, for a cable station that is broadcasting a audio channel unaccompanied by video.

### Example 3

A database of signal abstracts based on methods described herein to enable distinguishable and bit-addressable identification of the signal abstracts is available to rightsholders and those seeking the content for which the rights accrue. Such a database may be access restricted to users with a password, or a user dependent identifier, such as a password or cryptographically secure digital signature, and may be available to public networks, such as the World Wide Web, or any private derivation or Virtual Private Network, such as with subscription services (cable or satellite television systems, for instance). Differences between the publicly and privately available networks may have include access restricted protocols built in, or may also be differentiated in terms of the quality level of signals available to users (e.g., MP3 may be available in public networks, while DVD-Audio may only be available to private networks, based on the perceptible difference in the signals available). Publicly accessible databases may form the basis of better global identifiers than for instance, ISBN or ISRC (books and music recordings), in that abstracts may be subject to more appropriate machine readable differences by an audience of users. Privately generated identifiers, the signal abstracts, may alternatively be controlled by a rightsholder to assure the rightsholder their work is being paid for Peer-to-peer networks could benefit from embodiments disclosed in the present invention as an efficient way for linking signal abstracts with versions intended for commerce.

The rightsholder may choose to create a signal abstract by means disclosed herein to enable a signal dependent database to be accessible to those seeking the signal as represented in a file format (CD, MP3, DVD, etc) where the signal abstract is represented in the database, or a version which may have differences from other versions. Any bit-addressable pointers which can link a seeker of the signal(s) to a location for which downloading or streaming of the signal is possible may also be supported. Once a signal is determined to represent the signal abstract represented in the database, a logical means for accessing the signal in some predetermined format (such as MP3, AAC, CD, DVD-Audio) for that signal is established. The signal is matched with the request and any information required to initiate the transfer of the file, such as payment, subscription record, verification of a predetermined identification for the user, may be used to further tag the distributed signal with the unique identifying information. Such information may include a user dependent digital signature of the signal or a digital watermark embedded in the signal to be distributed. Any pre-analyzed versions of the perceptible characteristics of the saved signal may be referenced to speed downloading of the requested signal. For example, for a particular song that is requested by multiple users, it is not necessary to require that the uniqueness introduced into the signal has a perceptible analysis of the signal for each encoding of the unique identifier (some pre-analysis of the signal sought can be referenced for any subsequent matching of user requests with actual transactions of the signal).

The pre-analysis may be concatenated with the user-dependent unique identification information (for instance a transactional watermark, or a digital signature) to speed and optimize transactions and can be saved for future reference. A record of the signal abstract matching a location for the signal, or a pre-analysis of the perceptible features of the signal deemed intrinsic to the user dependent step of encoding prior to download or subscription of the signal content is within the contemplation of the present invention. Any adjustment to signal abstracts for new releases of the previously released material, in signal form may constitute an additional signal abstract entry into the database. Additionally, for those signals which are deemed of higher commercial value, a series of similar signal abstracts differentiated by cryptographic protocols, such as hashes or signatures for a representative signal abstract, may be saved in the database to enable higher uniqueness and differentiation between the same signals, and demands for the signal being made for a universal or global directory of the signal. This plays a role in assisting with differentiations being made between the same song, for instance, in different locations, or different versions (for instance, where the song is the same, but any coupled information such as lyrics, images, or other data associated with the song are made unique or differ representing the same song but a different package for that song). The present invention may be combined with other means for screening data signals for which the database may apply. One example is the Secure Protected Content Server application disclosed by the present inventors.

### Example 4

Napster™ is an Internet service that provides a collection of links to audio content that are not controlled by the service. This may include both copyrighted and uncopyrighted works. Napster™ currently claims that it does not have the technological ability to determine the identity, and therefore the distribution status, such as the copyright status, of the audio at each link. In general, music companies want Napster™ to exist in principle, but also wants to prevent distribution of valued properties without proper payment.

The present invention could provide Napster™, or a similar program, with the ability to identify the audio at the links. Each music company would create a data-compressed database of all of the abstracts of audio content that it wished to prevent Napster™ from distributing. The music company may make this their entire music catalog, or it may only be a subset of the catalog, because the music company may wish for certain tracks to be available for promotion. Each time a new link is submitted to Napster™, a Napster™ computer downloads the link, creates an abstract, and compares it against the databases for the music companies. If the abstract from the link matches one in the database, Napster™ would make the link unavailable, thus preventing distribution of the audio. If no match is found, the audio is assumed to uncontrolled content, and the link is permitted, allowing distribution.

It should be noted that, although this discussion is made with reference to digital music, it may also be used with digital images, digital audio, digital video, or a combination thereof. Thus, the databases may be created and/or provided by a music company, a movie studio, an image archive, etc. Additionally, Napster™ can act as a certification authority of the signal abstracts and also linking to signals can be by inclusion of cryptographic protocols for the abstracts. Napster™ can maintain a public key directory for users, signal abstracts and the signals themselves, to better enable successful searches, links and transactions of any digitized signal.

Other embodiments and uses of the invention will be apparent to those skilled in the art from consideration of the specification and practice of the invention disclosed herein. The specification and examples should be considered exemplary only with the true scope and spirit of the invention indicated by the following claims. As will be easily understood by those of ordinary skill in the art, variations and modifications of each of the disclosed embodiments can be easily made within the scope of this invention as defined by the following claims.

What is claimed is:

1. An electronic system for monitoring and analyzing at least one signal, comprising:
a first input that receives at least one reference signal to be monitored;
a first processor that creates an abstract of each reference signal input to said first processor through said first input;
a second input that receives at least one query signal to be analyzed;
a second processor that creates an abstract of each query signal;
a reference database that stores abstracts of each at least one reference signal;
a comparing device that compares an abstract of said at least one query signal to the abstracts stored in the reference database to determine if the abstract of said at least one query signal matches any of the stored abstracts; and
a device that permits submission of reference signal abstracts to the reference database.

2. The system of claim 1, wherein the device that permits submission of reference signal abstracts provides a database rights and restriction report, the database rights and restriction report comprising the attendant rights and restrictions associated with any stored abstract associated with a positive result.

3. The system of claim 1, wherein the reference database is available to the public.

4. The system of claim 1, wherein access to the reference database is limited to at least one of specific members of the public and specific companies.

5. The system of claim 2, wherein the database rights and restrictions report is used to determine pricing.

6. The system of claim 2, wherein the database rights and restrictions report is used to determine suitable content members for a searchable index of content.

7. The system of claim 2, wherein the database rights and restrictions report is used to associate content with external value-adding components created by a rightsholder.

8. The system of claim 1, wherein said second input is remotely coupled to the system.

9. The system of claim 1, wherein said second processor is remotely coupled to the system.

10. The system of claim 1, wherein the system transmits the criteria that are being used by the first processor to the second processor.

11. The system of claim 1, further comprising:
a storage medium coupled to said first input, the storage medium storing each of said at least one reference signals to be monitored; and
a controller that compares an abstract for each reference signal being input for the first time to be compared to all previously stored abstracts in the reference database, such that in the event that the comparing device determines that it cannot distinguish between the abstract of a reference signal being input for the first time from a previously stored abstract in the reference database, the controller adjusts the criteria being used by the processor and re-generates the reference database, by re-processing each reference signal stored on the storage medium to create new abstracts and storing said new abstracts in the reference database.

12. The system of claim 1, wherein the reference database acts as a certification authority.

13. A electronic system for monitoring and analyzing a plurality of signals, comprising:
a first input for receiving a plurality of reference signals to be monitored;
a first processor for creating a plurality of abstracts corresponding to the plurality of reference signals;
a reference database for storing the reference signal abstracts;
a second input for receiving a query signal to be analyzed;
a second processor for creating an abstract of the query signal;
a comparing device that compares the query signal abstract to the reference signal abstracts and determines if the query signal abstract matches at least one of the reference signal abstracts; and
a means for linking the query signal abstract to the reference signal corresponding to the matching reference signal abstract.

14. The system of claim 13, wherein the linking is dependent on predetermined access rules.

15. The system of claim 13, wherein the linking is differentiated by at least one of signal quality, value adding components, URL, geographic parameter, time-based parameter, payment terms and conditions, user dependent identification, and combinations thereof.

16. The system of claim 13, wherein the abstract represents a set of related abstracts for substantially the same signal.

17. The system of claim 13, wherein the abstract is distributed to a plurality of locations to optimize linking of abstracts with said abstract's representative signal.

18. The system of claim 13, wherein the means for linking the query signal abstract to the reference signal corresponding to the matching reference signal abstract is bidirectional.

19. The system of claim 18, wherein the linking is performed by a device with the functionality to link electronically with the abstract.

20. The system of claim 18, wherein the bidirectional linking enables adjustments based on at least one of a number of access requests, types of signal versions requested, identification information of access devices, payment, location, and combinations thereof.

21. The system of claim 13, wherein the electronic system is accessible over at least one of a public network and a private network.

22. The system of claim 13, further comprising:
a means for a user to monitor the comparison device.

23. The system of claim 22, wherein the means for a user to monitor the comparison device is part of a web browser.

24. The system of claim 22, wherein the means for a user to monitor the comparison device is part of at least one of a caching function and a filtering function.

25. The system of claim 23, further comprising:
a means for non-owners of the reference database to submit reference signal abstracts to the reference database.

26. The system of claim 13, wherein the reference database acts as a certification authority.

27. The system of claim 13, further comprising:
a device for embedding each reference signal with its corresponding reference signal abstract.

28. The system of claim 27, wherein the reference signal abstract is hashed before it is embedded.

29. The system of claim 27, wherein the reference signal abstract is digitally signed before it is embedded.

30. The system of claim 13, wherein the reference signal corresponding to the matching reference signal abstract is downloadable.

31. The system of claim 30, wherein the reference signal abstract is embedded into the matching reference signal before the reference signal is downloaded.

32. A method for monitoring a signal, comprising:
receiving a reference signal to be monitored;
creating an abstract corresponding to the reference signal;
linking the abstract to at least one signal to be referenced; and
embedding the abstract in the at least one signal to be referenced.

33. The method of claim 32, wherein the abstract is held by a certification authority.

34. The method of claim 32, wherein the abstract is embedded with a predetermined key.

35. The method of claim 32, wherein the abstract is hashed before it is embedded.

36. The method of claim 35, wherein the hash of the abstract is embedded.

37. The method of claim 35, wherein the abstract is combined with a kind of information selected from the group consisting of an identity of a user, a receipt of a transaction, an identity of a distribution chain, an identity of a device, a predetermined key, and combinations thereof, before the abstract is hashed.

38. The system of claim 32, wherein the abstract is digitally signed before it is embedded.

39. The method of claim 38, wherein the signature of the abstract is embedded.

40. The method of claim 29, wherein the abstract is combined with a kind of information selected from the group consisting of an identity of a user, a receipt of a transaction, an identity of a distribution chain, an identity of a device, a predetermined key, and combinations thereof, before the abstract is digitally signed.

41. A method for controlling the distribution of digital signals, comprising:
creating an abstract for a first digital signal, the first digital signal having an unknown distribution status;
comparing the first digital signal abstract to at least one database of digital signal abstracts, each abstract in the at least one database corresponding to a digital signal having a known distribution status; and
determining the distribution status for the first digital signal based on the comparison.

42. The method of claim 41, wherein the step of determining the distribution status for the first digital signal based on the comparison comprises:
permitting distribution of the first digital signal responsive to the first digital signal abstract not matching one of the digital signature abstracts in the at least one database.

43. The method of claim 41, wherein the step of determining the distribution status for the first digital signal based on the comparison comprises:
permitting a link to the first digital signal responsive to the first digital signal abstract not matching one of the digital signal abstracts in the at least one database.

44. The method of claim 41, wherein the step of determining the distribution status for the first digital signal based on the comparison comprises:
not permitting distribution of the first digital signal responsive to the first digital signal abstract matching at least one of the digital signal abstracts in the at least one database.

45. The method of claim 41, wherein the step of determining the distribution status for the first digital signal based on the comparison comprises:
not permitting a link to the first digital signal responsive to the first digital signal abstract matching at least one of the digital signal abstracts in the at least one database.

46. The method of claim 41, wherein the database is created by at least of a music company, a movie studio, an image archive, and a combination thereof.

47. The method of claim 41, wherein the digital signals comprise at least one of digital images, digital audio and digital video.

48. The method of claim 41, wherein the distribution status comprises a copyright status.

49. The system of claim 1, wherein the abstract is created by:
determining invariant characteristics for the reference signal;
selecting the invariant characteristics that have a minimum variation with the stored abstracts in the reference database; and
defining a null case as a minimum variation from all stored abstracts in the reference database.

50. The method of claim 41, wherein the step of creating an abstract for a first digital signal comprises:
determining invariant characteristics for the first digital signal;
selecting the invariant characteristics that have a minimum variation with the abstracts in the at least one database of digital signal abstracts; and
defining a null case as a minimum variation from all the abstracts in the at least one database of digital signal abstracts.

51. The system of claim 13, further comprising:
a device for attaching the corresponding reference signal abstract to each reference signal.

52. The system of claim 13, further comprising:
a device for associating the corresponding reference signal abstract with each reference signal.

53. The system of claim 13, wherein the linked reference signal is embedded with user dependent information.

54. The system of claim 53, wherein the user dependent information includes at least one of a user identification and a user address.

55. The system of claim 53, wherein the user dependent information is hashed prior to embedding.

56. The system of claim 53, wherein the user dependent information is digitally signed prior to embedding.

57. The system of claim 13, wherein the comparing device determines whether the query signal is an authorized signal.

58. A system for searching for and distributing electronic data, compromising:
a first input that receives a query abstract of a signal to locate;
a database containing a plurality of signal abstracts, the plurality of signal abstracts each having a corresponding signal;
a comparing device that compares the query abstract to the plurality of abstracts stored in the reference database to identify a matching signal abstract; and
a device for retrieving the signal corresponding to the matching signal abstract; and
a device for conducting a transaction, the transaction selected from the group consisting of a download and a subscription.

59. The system of claim 58, wherein each signal abstract comprises a link to its corresponding signal.

60. The system of claim 58, wherein the comparing device determines if the signal abstracts stored in the database are authorized.

61. The system of claim 59, wherein the comparing device determines if the link is an authorized link.
